(19) United States
(12) Patent Application Publication
(10) Pub. No.: US 2012/0134663 A1
(43) Pub. Date: May 31, 2012

(54) SYSTEM AND METHOD FOR MANAGING OPTICAL SYSTEM FAILURE

(76) Inventors: Hongsheng Wang, Bound Brook, NJ (US); Richard Chen, Belie Meade, NJ (US); Zemer Mizrahi, Jersey City, NJ (US); Ali Ouali, Upper Darby, PA (US); Boris Stefanov, Hellertown, PA (US)

(21) Appl. No.: 12/955,407

(22) Filed: Nov. 29, 2010

(51) Int. Cl. H04B 10/08; G01N 21/00; H04B 10/14

(52) U.S. Cl. 398/5; 398/16; 356/73.1

(57) ABSTRACT

A reflector assembly is disclosed that may include a housing; a fiber stud disposed within the housing; a filter lens having an OTDR reflective layer, the filter lens located downstream from the fiber stud and receiving light energy from the fiber stud, and configured to be transparent for light within a communication wavelength band and reflective within a diagnostic wavelength band.

### BACKGROUND OF THE INVENTION

Existing optical communication systems sometimes include a primary optical communication path and a protection path (also referred to as a backup path) for use in the event of fault or failure on the primary optical path. When only optical data is being transferred within a system, the existing protection path mechanism may be adequate to enable communication to continue despite the existence of a disruption in the primary path.

However, more modern communication systems may include one or more data streams that converge with data on the optical data paths at a downstream location. Such other data streams may include optical or other forms of data. In the event of a failure on the primary optical path, the additional data streams continue to supply data intended to converge with the primary optical data path. However, with the primary optical data path in a failure mode, the additional data streams will end up going unused and be lost.

Accordingly, there is a need in the art for an improved system and method for combining data on a primary optical data path with one or more additional data streams in the event of a fault condition on a primary data path.

### SUMMARY OF THE INVENTION

According to one aspect, the invention is directed to a system that may include an optical line terminal (OLT); an optical splitter; primary and backup optical paths extending from the optical line terminal to the optical splitter; a video feed system having a first and second video output paths; and a network management system in communication with the OLT and operable, in the event of a fault, to cause the video feed to switch a flow of video data from the first video output to the second video output path and to merge the video with the backup optical path extending from the OLT to the optical splitter, thereby providing a merged data stream.

According to another aspect, the invention is directed to a reflector assembly that may include a housing; a fiber stud disposed within the housing; a filter lens having an OTDR reflective layer, the filter lens located downstream from the fiber stud and receiving light energy from the fiber stud, and configured to be transparent for light within a communication wavelength band and reflective within a diagnostic wavelength band.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a communication system in accordance with an embodiment of the present invention;

FIG. 2 is a block diagram of a portion of an optical communication system including reflectors disposed near optical network terminals in accordance with an embodiment of the present invention;

FIG. 3 is a partially sectional and partially schematic view of an embodiment of a reflector assembly in accordance with an embodiment of the present invention;

FIG. 4 is a partially sectional and partially schematic view of an embodiment of a reflector assembly in accordance with an embodiment of the present invention;

FIG. 5 is a partially sectional and partially schematic view of an embodiment of a reflector assembly in accordance with an embodiment of the present invention;

FIG. 6 is a partially sectional and partially schematic view of an embodiment of a reflector assembly in accordance with an embodiment of the present invention;

FIG. 7 is a schematic representation of an embodiment of a reflector assembly in accordance with an embodiment of the present invention;

FIG. 8 is schematic representation of an embodiment of a reflector assembly in accordance with an embodiment of the present invention; and

FIG. 9 is a block diagram of a computer system useable with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

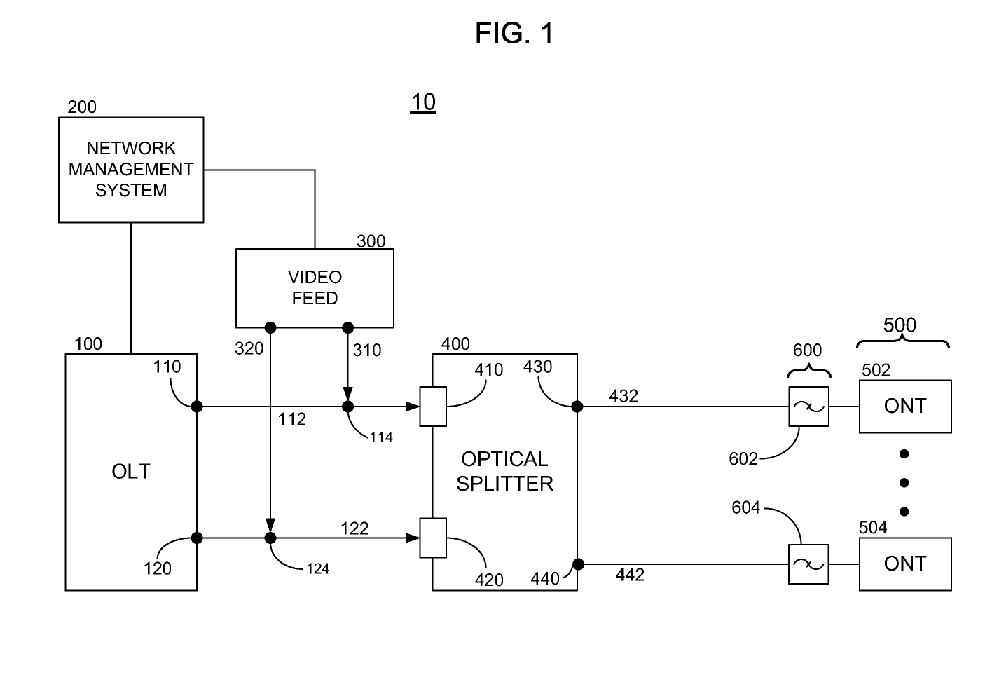

FIG. 1 is a block diagram of a communication system 10 in accordance with an embodiment of the present invention. Communication system 10 may include Optical Line Terminal (OLT) 100, network management system (NMS) 200, video feed source (also referred to as “video feed”) 300, optical splitter 400, optical network terminals (ONTs) 500, and reflectors 600. OLT 100 may include ports 110 and 120, which are coupled, to optical paths 112 and 122 respectively.

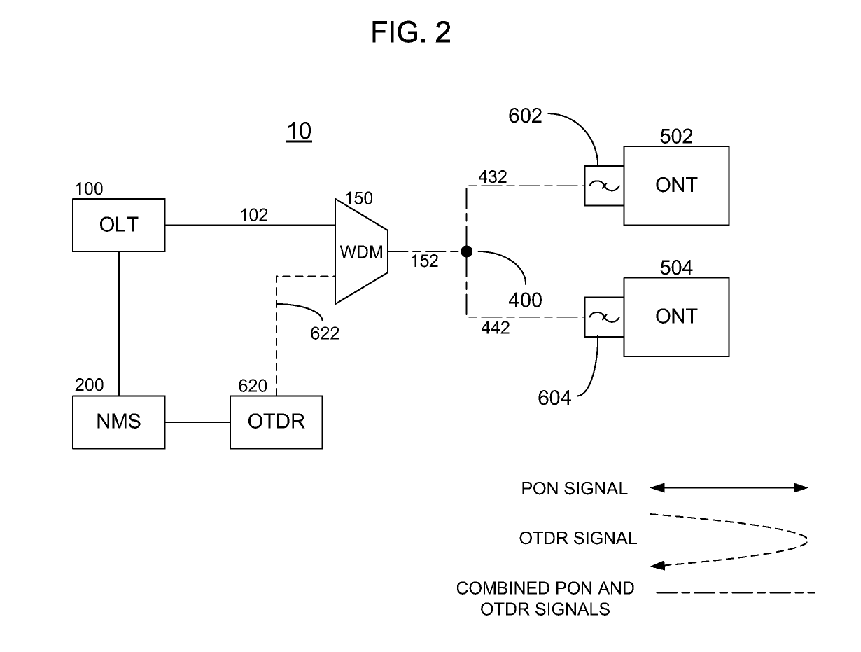

Video feed 300 may include video data communication paths 310 and 320 which may be configured to converge with optical data paths 112 and 122 respectively. Optical splitter 400 may include upstream (i.e. OLT side) ports 410 and 420 and downstream (i.e. ONT side) ports 430 and 440 which may be coupled to optical paths 432 and 442 respectively. ONTs 500 and reflectors 600 are discussed in greater detail in connection with FIG. 2.

Under normal operating conditions, OLT 100 conducts optical data communication with optical splitter 400 along primary optical data path 112. Moreover, video feed 300 provides video data that is configured to merge with the optical data from OLT 100 along primary video data path 310. Data paths 310 and 112 are shown converging at node 114. Node 114 is shown at a mid-point along path 112 for the sake of convenience. The optical and video data paths preferably converge within port 410 of optical splitter 400. However, the present invention is not limited to this implementation. The combination of the video and optical data paths could be combined at any desired point.

In the event of a fault condition, OLT 100 transfers the flow of optical data from port 110 and primary data path 112 to port 120 and backup data path 122. In order to ensure that the process of combining of video data from video feed 300 and optical data through OLT 100 continues, OLT 100 notifies network management system 200 of the fault condition. Upon being notified the fault condition, network management system 200 preferably causes video feed 300 to switch the flow of video data from data path 310 to data path 320 so as to combine the video data with the data on backup optical path 122. The video data and optical data, for the sake of convenience, are shown converging at node 124. However, system 10 may be configured to cause the actual physical combination of the two data streams to occur wherever this data convergence can be most effectively accomplished.

Thus, the data streams from video data path 320 and optical data path 120 are combined once at port 420 of optical splitter 420. In the above manner, video feed 300 and/or other possible sources of data suitable for combination with data from OLT 100 may be switched to suitable alternative data paths in the event of a fault condition on the primary optical data path 112.

FIG. 2 is a block diagram of a portion of an optical communication system 10 including reflectors 602, 604 near ONTs 502, 504, respectively, in accordance with an embodiment of the present invention. The portion of system 10 shown in FIG. 2 includes OLT 100, Optical Time-Domain Reflectometer (OTDR) 620, multiplexer 150, ONTs 500, reflectors 602 604, and suitably placed fiber optic links extending between the various components. Signals at different frequencies/wavelengths are designated using different respective graphical symbols in FIG. 2. Specifically, the standard passive optical network (PON) signals preferably employs signals with wavelengths below 1625 nanometers (nm), and more preferably at or below 1585 nm. OTDR signal generator 620 may include an OTDR signal measurement device to measure OTDR signal energy reflected by one of reflectors 600. Alternatively, the OTDR signal measurement capability may be located anywhere else in system 10 either in a stand-alone device or while integrated into another optical component shown in FIG. 2. While the OTDR signal generator 620 is shown coupled to multiplexer 150, it will be appreciated that OTDR signal generator 620 could be located elsewhere within system 10, such as (a) along the optical paths between multiplexer 150 and a selected one of the ONTs 500; or in between OLT 100 and multiplexer 150; or integrated into one of the other optical circuit components shown in system 10.

The path of standard PON communication signals (also referred to as communication signal energy) is indicated by solid line 102. The OTDR signal energy preferably includes signal energy with a wavelength of between about 1625 nm and 1670 nm and is indicated with dashed line 622 which includes dashes of substantially equal length. Links in system 10 carrying a combination of PON communication 102 and OTDR signals 620 are indicated using a combined signal 152 indicated with a dashed line that includes dashes of unequal length.

For the sake of convenience, the communication from OTDR device 620 is marked as a dashed line, with reference numeral 622, identifying the OTDR signal present on that link. Likewise, other signal types have identifiers, such as conventional PON communication out of OLT 100, which is designated with reference numeral 102. It is believed helpful to identify the preferred type of physical link in each section of the system shown in FIG. 2. In general, except for the links to NMS 200, all links between the various devices shown in FIG. 2 are preferably implemented using suitably selected fiber optic cabling. In the case of NMS 200, conventional electrical connections (such as between NMS 200 and OLT 100, and between NMS 200 and OTDR device 620) may be employed for signaling with NMS 200 either in place of, or in addition to, the use of fiber optic links.

Under normal operation, in the absence of a fault condition, a standard stream of optical data proceeds from OLT 100 over a fiber optic link to multiplexer 150, is then split at splitter 400, and then proceeds along paths 432 and 442 toward ONTs 502 and 504 respectively. If OLT 100 detects a communication failure between OLT 100 and any of ONTs 500, OTDR signaling device 620 is preferably activated. It is noted that, in the prior art, it would be difficult to determine whether the communication failure resides somewhere on the optical fiber links coupling the various devices or within one of the ONT 500 devices.

Upon determining that a communication breakdown exists somewhere between OLT 100 and ONT 502 (or any other ONT), the OLT 100 may notify NMS 200 of the fault condition. NMS 200 may then instruct OTDR signal generator 620 (or other suitable device) to transmit a test signal and then measure for any reflection of the test signal to determine whether the fault lies between multiplexer 150 and one of reflectors 602 or 604. The OTDR test signal 622 may have a wavelength between about 1625 nm and 1670 nm. However, the invention is not limited to the above-specified wavelength, and test signals having other wavelength values may be employed for OTDR test signal 622. Once the test signal is transmitted, the OTDR test signal is preferably reflected by reflector 602 or 604, even while reflectors 602, 604 allow non-OTDR light energy to pass therethrough mostly or completely undisturbed.

After sending the test signal, OTDR 620 preferably measures any reflected signal energy along the fiber link between OTDR 620 and multiplexer 150. If significant reflected signal energy is present, system 10 presumes that all fiber links in system 10 are operational and that the ONT to which the PON message was sent from OLT 100 is at fault. A threshold may be established above which the method disclosed herein determines that the OTDR signal is being reflected and the fault lies with the ONT 500. If reflected OTDR signal energy is below the threshold, the method disclosed herein preferably determines that there is a failure in the optical link leading upstream from the ONT 500 being tested. The pertinent threshold may be set to any desired proportion of the magnitude of the outgoing OTDR test signal, such as but not limited to 70%, 60%, 50%, 40%, 30%, 20%, 10% or other proportion of the magnitude of the outgoing OTDR test signal 622.

In one embodiment, if reflected OTDR signal energy is not detected at OTDR 620, the system 10 presumes that a fiber link between OTDR 620 and an ONT 500 has failed. In the case where multiplexer 150 is located very close to OTDR 620, the fiber link failure is presumed to have occurred between multiplexer 150 and the ONT 500 to which the PON message was sent by OLT 100.

Where needed, in order to ensure the reflected OTDR signal energy 622 is being reflected by the ONT 500 of interest, and not a different ONT, the outgoing OTDR signals may be adjusted such that wavelength of the outgoing OTDR signal has a different value for each ONT that is in communication with multiplexer 150. Alternatively, the outgoing OTDR test signal from OTDR device 620 may include an address designation to ensure that the OTDR test signal is sent only along the optical path of interest (such as, for instance, the optical path leading to ONT 502).

Various embodiments of the system shown in FIG. 2 may include the following benefits. The reflectors 602, 604 are preferably transparent to all conventionally employed PON signals (i.e. signal energy within a wavelength typically used for communication), thereby preventing any disturbance of non-OTDR signal energy. The reflectors may be constructed and implemented in a manner that is independent of ONT vendors, thereby enabling the reflectors to be used with ONTs from a range of possible manufacturers. Reflectors according to embodiments of the present invention can be made inexpensively and may be permanently installed within an optical circuit.

The OTDR signal 622 may be configured to include clear peaks to enable easy location and identification of the various ONTs. The use of high-precision reflectors, such as for reflectors 602 and 604, makes it possible to diagnose subtle changes in the optical links within system 10. The determination of the location of the fault, using reflectors 602, 604 preferably enables a clear separation of maintenance and repair responsibilities between the service provider and a customer-owned ONT 500.

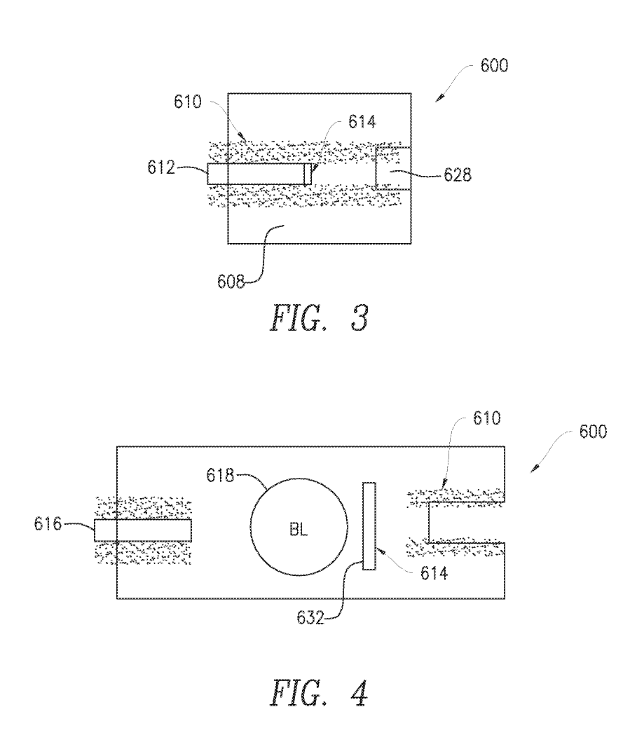

FIG. 3 shows one possible implementation of reflector 600 which includes housing 608, which includes notch 628 on the right-hand side. In the embodiment of FIG. 3, fiber ferrule 612 is located within tube 610 and abuts against a filter lens 632 having a reflective coating 614 (which may also be referred to as reflective layer 614). Preferably, the right side of reflector 600 (shown including a notch 628) is the upstream side (i.e. the side receiving light energy from the OLT 100), and the left side of reflector 600 directs light toward an ONT 600. The above-described relationship of the left and right sides of reflector assembly 600 for FIG. 3 apply to the embodiments shown in all of FIGS. 3-6, which all show a notch 628 on the right-hand side.

The materials for various components within reflector assembly 600 are briefly discussed here. Ball lens 618 is preferably made of glass. Fiber ferrule 612 is preferably made of ceramic. Housing 608 is preferably made of plastic. OTDR reflective layer 614 is preferably made of a multi-layer dielectric on glass.

FIG. 4 shows another embodiment of reflector 600 including a ball lens 618 in the center thereof. In this embodiment, mixed-signal light energy (i.e. light energy including both OTDR energy and conventional ONT signal energy) may enter on the right side. The OTDR signal energy is preferably reflected by reflective layer 614, while the conventional PON signal energy (typically at wavelengths below 1625 nm) proceeds on to ball lens 618, and beyond that on toward fiber stud 616.

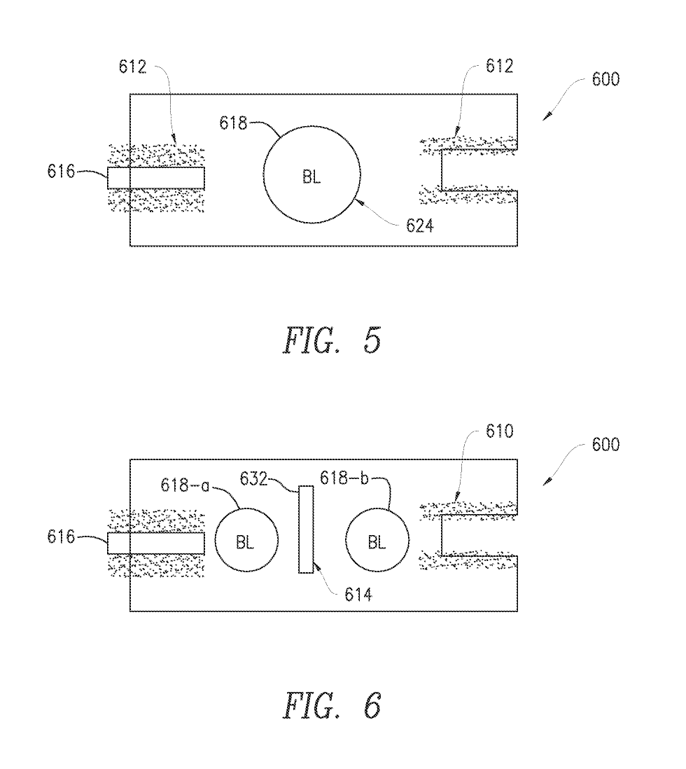

FIG. 5 shows yet another embodiment of reflector 600 including a ball lens 618 having a reflective layer 614 on the outside surface thereof. In this embodiment, mixed light energy enters reflector 600 at the notch on the right. Thereafter, OTDR light energy preferably reflects off the reflective outside surface 614 on the right side of ball lens 618 and does not advance further (in the leftward direction that is) within reflector 600. In contrast, conventional PON signal energy passes through reflective layer 614, proceeds into ball lens 618, incurs some scattering, where some portion of the scattered light then proceeds toward fiber stud 616.

FIG. 6 shows yet another embodiment of reflector 600 that includes two ball lenses 618-1, 618-b and an OTDR reflective layer 614 located in between the ball lenses. In this embodiment, light from the OLT 100 preferably enters at the right (in the view of FIG. 6) and gets dispersed by the first ball lens 618-b. The dispersed light preferably proceeds toward reflective layer 614 where the OTDR signal energy is preferably reflected, and where the PON signal energy preferably proceeds unimpeded. The PON signal energy light then gets dispersed by ball lens 618-a and gets conveyed out of reflector assembly 600 on fiber stud 616.

In some embodiments, the OTDR reflector 600 can be incorporated within an ONT 500 to achieve compactness and a high degree of compatibility between the reflector 600 and the remainder of the ONT 500. Alternatively, the OTDR reflector 600 could be embedded within a bi-directional optical sub-assembly (BOSA).

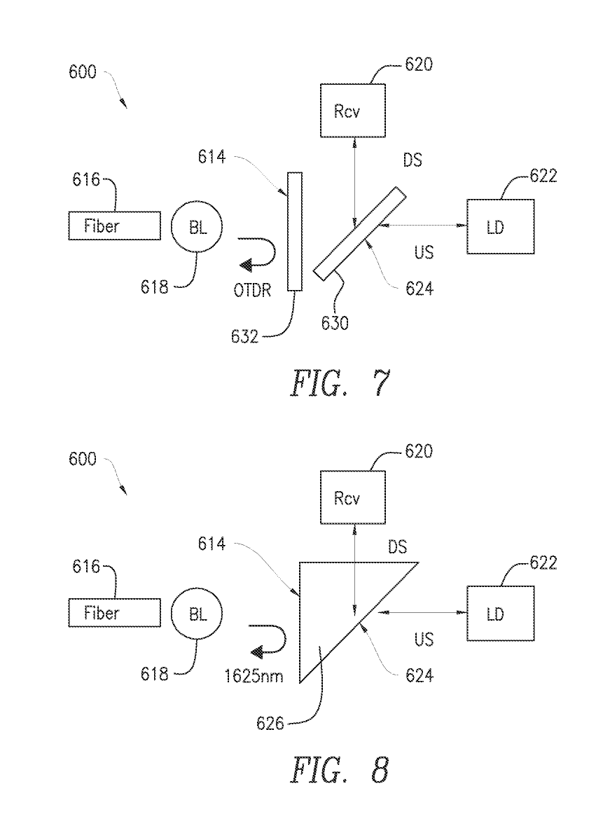

FIG. 7 is a schematic representation of an embodiment of a reflector assembly 600 in accordance with an embodiment of the present invention. In the embodiment of FIG. 7, mixed signal light (i.e. light including both PON and OTDR wavelengths) may enter reflector 600 at fiber portion 616 and get scattered by ball lens 618, and then get directed toward reflective layer 614. At reflective layer 614 the OTDR signal energy is preferably reflected back toward the fiber 616, while the PON signal energy preferably proceeds through reflective layer 614 toward second reflector 630 and is then reflected off reflector 624 toward receiver 620.

FIG. 8 is schematic representation of an embodiment of a reflector assembly 600 in accordance with an embodiment of the present invention. In this embodiment, mixed light energy reflector assembly 600 at fiber portion 616 and proceeds toward ball lens 618. After proceeding through ball lens 618, the mixed-signal light energy reaches reflective surface 614 (on prism 626) which surface allows the PON signal energy to proceed therethrough, but which reflects OTDR signal energy (which typically has a wavelength between 1625 nm and 1670 nm) back toward fiber portion 616. The PON light energy then proceeds through prism 626 and reflects off surface 624 toward receiver 620.

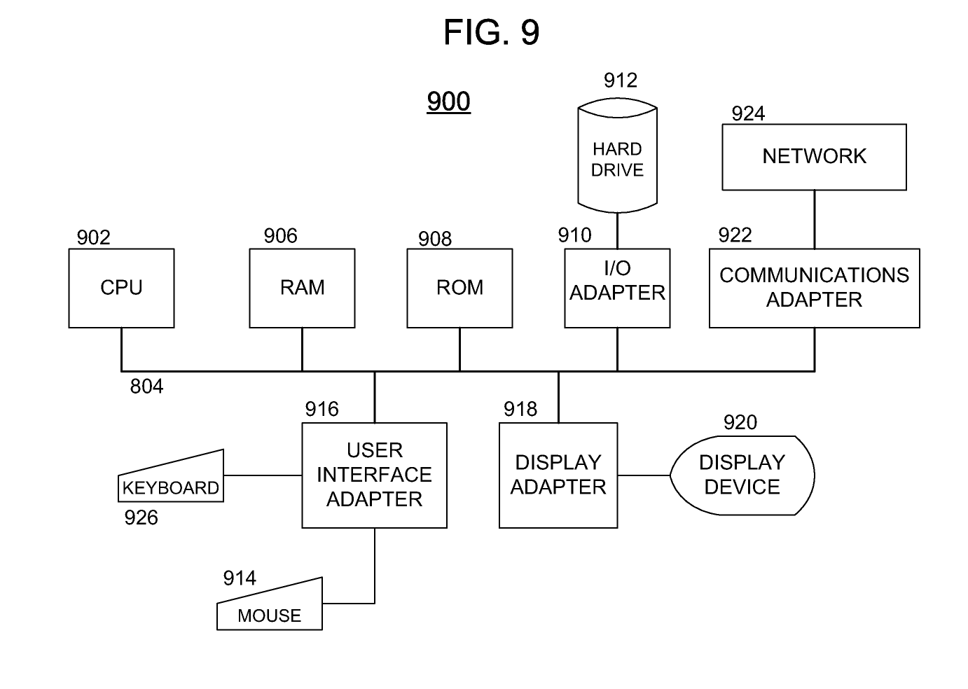

FIG. 9 is a block diagram of a computing system 900 adaptable for use with one or more embodiments of the present invention. Central processing unit (CPU) 902 may be coupled to bus 904. In addition, bus 904 may be coupled to random access memory (RAM) 906, read only memory (ROM) 908, input/output (I/O) adapter 910, communications adapter 922, user interface adapter 906, and display adapter 918.

In an embodiment, RAM 906 and/or ROM 908 may hold user data, system data, and/or programs. I/O adapter 910 may connect storage devices, such as hard drive 912, a CD-ROM (not shown), or other mass storage device to computing system 900. Communications adapter 922 may couple computing system 900 to a local, wide-area, or global network 924. User interface adapter 916 may couple user input devices, such as keyboard 926, scanner 928 and/or pointing device 914, to computing system 900. Moreover, display adapter 918 may be driven by CPU 902 to control the display on display device 920. CPU 902 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system comprising:
an optical line terminal (OLT);
an optical splitter;
primary and backup optical paths extending from the optical line terminal to the optical splitter;
a video feed system having a first and second video output paths; and
a network management system in communication with the OLT and operable, in the event of a fault, to cause the video feed to switch a flow of video data from the first video output to the second video output path and to merge the video with the backup optical path extending from the OLT to the optical splitter, thereby providing a merged data stream.

2. The system of claim 1 wherein communication between the OLT and the network management system occurs electronically.

3. The system of claim 1 wherein communication between the OLT and the network management system occurs over an optical communication link.

4. The system of claim 1 wherein the optical splitter is operable, in the event of a fault, to switch from a primary port to a backup port for receiving the merged data stream.

5. The system of claim 1 wherein the network management system is operable upon removal of the fault condition to cause the video feed to switch a flow of video data from the second video output to the first video output.

6. A system comprising:
an optical transmitter operable to transmit light energy along a fiber;
a reflector, receiving light energy from the fiber, and configured to be transparent for light within a communication wavelength band and reflective within a diagnostic wavelength band.

7. The system of claim 6 wherein the communication wavelength band is between about 1625 nanometers (nm) and about 1670 nm.

8. The system of claim 6 wherein the communication wavelength band is below 1585 nm.

9. The system of claim 6 wherein the reflector is located in proximity to and in communication with a network optical terminal (ONT).

10. The system of claim 6 wherein the reflector is incorporated within the ONT.

11. A reflector assembly comprising:
a housing;
a fiber stud disposed within the housing;
a filter lens having an OTDR reflective layer, the filter lens located downstream from the fiber stud and receiving light energy from the fiber stud, and configured to be transparent for light within a communication wavelength band and reflective within a diagnostic wavelength band.

12. The reflector assembly of claim 11 wherein the communication wavelength band is between about 1625 nanometers (nm) and about 1670 nm; and wherein the communication wavelength band is below 1585 nm.

13. The reflector assembly of claim 11 wherein the filter lens is a ball lens and the reflective layer is disposed on an outer surface of the ball.

14. The reflector assembly of claim 11 further comprising:
a first ball lens located upstream from the filter lens.

15. The reflector assembly of claim 14 further comprising:
a second ball lens located downstream from the filter lens.

16. The reflector assembly of claim 11 further comprising:
a second reflector for reflecting communication wavelength band light toward a receiver.

17. The reflector assembly of claim 11 wherein the filter lens is in the form of a prism, wherein the OTDR reflective layer is disposed on a first surface of the prism.

18. The reflector assembly of claim 17 wherein a second surface of the prism has a communication-signal-light reflective layer thereon.

19. A method, comprising:
providing an OTDR reflector in proximity to an optical network terminal (ONT) in an optical network, the reflector being reflective of energy within a test-signal wavelength range and transparent to signal energy within a communication-signal wavelength range;
monitoring optical communication between an optical line terminal (OLT) and a the ONT;
upon detection of a fault condition in the monitoring step, transmitting a test signal within a test-signal wavelength range from an OTDR signal generator to the ONT.

20. The method of claim 19 further comprising:
measuring reflected OTDR signal energy on a link coupled to the OTDR signal generator.

21. The method of claim 20 further comprising:
determining that the ONT is faulty if the magnitude of the reflected OTDR signal energy is above a predetermined threshold proportion of the test signal magnitude.

22. The method of claim 21 wherein the predetermined threshold proportion of the test signal magnitude is one of the group consisting of: 60%; 50%; 40%; and 20%.

23. The method of claim 20 further comprising:
determining that the upstream optical link from the ONT is faulty if the magnitude of the reflected OTDR signal energy is below a predetermined threshold proportion of the OTDR test signal magnitude.

24. The method of claim 19 wherein the test-signal wavelength range is between about 1625 nm and 1670 nm.

25. The method of claim 19 wherein the communication signal wavelength range is below about 1585 nm.

26. The method of claim 19 wherein the OTDR reflector is incorporated within the ONT.
